(19) United States
(12) Patent Application Publication
(10) Pub. No.: US 2024/0155341 A1
(43) Pub. Date: May 9, 2024

(54) AUTHENTICATION OF DEVICE INTEGRATION FOR BLOCKING REMOTE MALICIOUS USAGE

(71) Applicant: Meishar H.Z. Yazamut Ltd., Meishar (IL)

(72) Inventor: Zeev SMILANSKY, Meishar (IL)

(21) Appl. No.: 18/387,963

(22) Filed: Nov. 8, 2023

Related U.S. Application Data
(60) Provisional application No. 63/423,505, filed on Nov. 8, 2022.

(51) Int. Cl. H04W 12/06; H04W 12/50

(52) U.S. Cl. CPC H04W 12/06; H04W 12/50

(57) ABSTRACT

An electronic system comprising: a target component and an input unit, the input unit is configured to receive a command from a user of the electronic system; the input unit stores a unique non-configurable code, the input unit is configured to receive a physical request to activate the target component, the input unit is coupled to the target component with an interface component, said interface is configured to enable a transfer of the unique non-configurable authentication code from a memory of the input unit to a memory address accessible to the target component, such that when the unique non-configurable code is correct, the target component is activated.

### CROSS REFERENCE TO RELATED APPLICATIONS

This application claims the benefit of priority of U.S. Provisional Patent Application No. 63/423,505, filed Nov. 8, 2022, the contents of which are all incorporated herein by reference in their entirety.

### TECHNICAL FIELD

The present disclosure relates to protection of systems with embedded electronic components from malicious remote attacks, in particular of malware hijacking key components of the system, such as camera or microphone in a smartphone or steering wheel and gas or brake pedals in a car.

### BACKGROUND

Smartphones today contain a growing part of their owner's records, memories, contacts, financials and indeed of their identity. Thus, privacy of the smartphone is as important as the privacy of its owner. Similarly, modern vehicles play a critical role in their owners' lives and, similar to a smartphone, contain many electronic processing units, governing processes in the vehicle, from steering and engine operation to air conditioning and entertainment.

Smartphones are the subject of immense malicious activity by a wide range of perpetrators, be they private, corporate or governmental. One particular such activity that achieved notoriety in recent times involves hijacking the smartphone's cameras and microphones, sometimes even without the user's awareness and permission, to obtain sensitive information. It is the object of this disclosure to describe an approach to block such remote usage of the smartphone's input devices. Similarly, modern vehicles are a critical target for malicious operations, where a third party could attempt to take control of the vehicle's engine, braking and/or steering systems.

Besides smartphones and vehicles, the approach of integration authentication could be used in any system that contains key electronic components, whether encapsulated into a single physical device or separated into several devices connected by wire or wirelessly that need to work together. In this disclosure we may use “system”, “smartphone” and “electronic system” interchangeably. While the discussion will focus on a smartphone or a vehicle as main examples, the concepts described here are no less relevant to power stations, public utilities, and any other relevant system that employs key electronic components.

A smartphone includes a large number of physical components, such as touch-screen, main processor, memory, battery, camera(s), microphone(s), external connectors, and so on. These are integrated into the smartphone's electronic boards and connected together electronically and mechanically in order to operate as designed. A large number of identical smartphones is manufactured in one production batch, typically hundreds of thousands or even millions of units.

Similarly, A vehicle includes a large number of electronic components governing, for example, the steering, the gas and the brake pedal, road lights, car doors etc. These are integrated into the vehicle and connected together electronically and mechanically in order to operate as designed. A large number of identical vehicles is manufactured in one production batch, typically hundreds of thousands or even millions of units.

While many of these components may have a serial number, they do not in current practice need to identify themselves to each other in order to communicate, activate, or send data. The present disclosure provides an architecture and approach that closes this security gap.

### SUMMARY OF THE INVENTION

The subject matter discloses an electronic system comprising: a target component and an input unit, the input unit is configured to receive a command from a user of the electronic system; the input unit stores a unique non-configurable code, the input unit is configured to receive a physical request to activate the target component, the input unit is coupled to the target component with an interface component, said interface is configured to enable a transfer of the unique non-configurable authentication code from a memory of the input unit to a memory address accessible to the target component, such that when the unique non-configurable code is correct, the target component is activated.

In some cases, the system is a smartphone. In some cases, the system is a vehicle. In some cases, the electronic system comprises at least one component configured to recognize whether a command was issued by one of the electronic system's components. In some cases, the input unit further comprises a coding circuit configured to code the non-configurable authentication code and wherein said code non-configurable authentication is unique for the electronic system.

In some cases, the code configuration is set during the production of the system after all the components have been set into the system. In some cases, the coding and decoding circuits are immutable. In some cases, setting the coding and decoding keys is performed during or after device integration. In some cases, the code transmitted from the input unit to the component is encrypted. In some cases, the code changes every minute, second, or millisecond. In some cases, the code is produced based on the system's clock.

The subject matter also discloses a method of controlling an operation of an electric component in a system the method comprises storing a non-immutable code in two components of the system; a sensing component of the system detecting a gesture targeting a target component of the two components; the sensing component sending the non-immutable code to the target component; if the non-immutable code matches a code stored in the target component, activating the target component.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a schematic illustration of the architecture of a smartphone, according to exemplary embodiments of the subject matter.

FIG. 1B shows a schematic illustration of the architecture of a vehicle having components activated using an immutable code, according to exemplary embodiments of the subject matter.

FIG. 2 shows a generalized flowchart of a method for camera operation initiated physically by the user e.g. from the touchpad, according to exemplary embodiments of the subject matter.

FIG. 3 shows a generalized flowchart of a method for camera operation initiated by an application or from a remote agent, according to exemplary embodiments of the subject matter.

FIG. 4A shows an integration authenticator with standard smartphone components, according to exemplary embodiments of the subject matter.

FIG. 4B shows a generalized flowchart of a method for setting an integration authenticator to secure components of a smartphone, according to exemplary embodiments of the subject matter.

### DETAILED DESCRIPTION

Smartphones are becoming more and more an intimate part of the human being, carrying her identity, memories, work, wealth and pleasure content, connecting her to bigger and bigger parts of her emotional, physical, financial and digital worlds.

Intrusion into a smartphone is becoming more and more destructive and dangerous for individuals as well as for people in any official position or capacity.

Significant effort is spent on protecting smartphones from intrusions, in particular protecting the act of obtaining data from the smartphone. However, an even more intrusive and dangerous methodology has reached notoriety in recent years—hijacking the input devices of the smartphone, that is, activating the camera, microphone, GPS and other devices by a malicious third party without the smartphone's owner realizing that his/her every move is recorded.

It is the objective of this disclosure to describe a smartphone architecture that can block such malicious activity, achieved through providing reliable credentials that the person holding the smartphone in their hand physically approves the usage of camera, microphone, GPS, and so on.

Similarly, vehicles, power stations, public utilities, and other key systems employ large numbers of integrated computers and can be the subject of malicious hijacking by third parties.

In what follows the term “system” can refer to a smartphone, a vehicle, a power station, or any other relevant system with key electronic components.

The present disclosure discloses component identification and integration authentication. Component identification teaches that the components of the smartphone, such as the cameras, touchpad, microphone, etc., or of any another system, are to be uniquely identifiable as belonging to that unique smartphone or system and to no other. Integration authentication is defined as the case in which the identification codes will be allocated and locked during system integration into the components' hardware, so that components of the smartphone or system cannot be replaced or switched post-authentication (except possibly under special instrumentation and authorization); that is, the authentication coding/decoding configuration is performed on all relevant components, once they were integrated into the system, and that configuration then becomes immutable, that is, cannot be changed in any way, for example by replacing a component, unless that component replacement was specifically authorized and performed in pre-approved workshops by approved personnel and using proprietary instrumentation that is authorized to read the code of the replaced component and add the code to the replacing component, for example by writing the code into the component's memory.

The components that become identifiable can be all the components or a specific subset of the system's components. Major components of a smartphone include a camera(s), microphone(s), processor, memory, touchpad, and external connectors e.g., for charging, USB, audio jack etc. Major components of a vehicle include a steering wheel, gas and brake pedals, door lock controllers, and so on.

In one embodiment, components can be defined as coders, decoders, or both. For example, a touchpad or a steering wheel can be defined as a coder of an authentication code, while a camera, processor, and microphone or an engine, braking system or door locks can be defined as decoders of the authentication code. In another embodiment, components can be both coders and decoders. In another embodiment, components can be neither.

Every component that is defined as a coder comprises, built into its hardware, a configurable-once coding circuit. Every component that is defined as a decoder comprises, built into its hardware, a configurable-once decoding circuit.

The configuration of the coding/decoding circuits is performed after the integration process is complete, using any of the relevant methodologies known in the industry for once-only configuration and for coding. Following configuration, the system is from now on immutable.

In some embodiments, the coding/decoding circuits are locked by changing physical properties of the component, for example by “write-once” approaches.

In some embodiments, the coding/decoding circuits utilize a system's clock to generate a code.

In some embodiments, the code is encrypted, so that even if a third party obtained the encrypted code in an inter-component message it would not be able to decrypt the code, to generate another code, or to decode a given code.

In some embodiments, the code is encrypted using the device clock so that the code changes continually.

In some embodiments, the code utilizes the serial numbers of the components being configured.

In some embodiments, the code changes every predefined period of time, such as minute, second, millisecond and so on.

During the integration process, the device is hooked to a computerized setup which configures all the coders and decoders on the components of the smartphone with a commensurate code and then locks the configuration using one of several approaches such as “write once”, gate burning or any other known methodology.

In some embodiments, the configuration is unique for every manufactured unit of a given type of device.

In some embodiments, this approach is used for mobile electronic devices other than smartphones, such as computers, servers, laptops, digital cameras, distributed devices, and so on.

In some embodiments, the coding/decoding configuration is dependent on a coding key. This coding key can be static or dynamic, can include a time-based component, and can be used with or without the device clock. The encryption can be symmetric or asymmetric. The encryption can rely on encryption standards such as in the Time-Based one-time password (TOTP) used in, for example, Google Authenticator, or can be a proprietary encryption system, providing that a. it ensures the authenticity of the device component sending a message and b. it cannot be deciphered by a third party even if the third party receives the encrypted message.

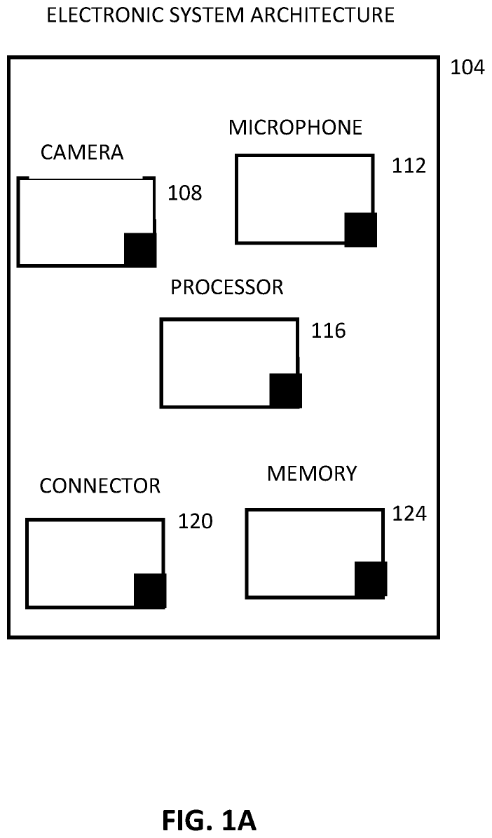

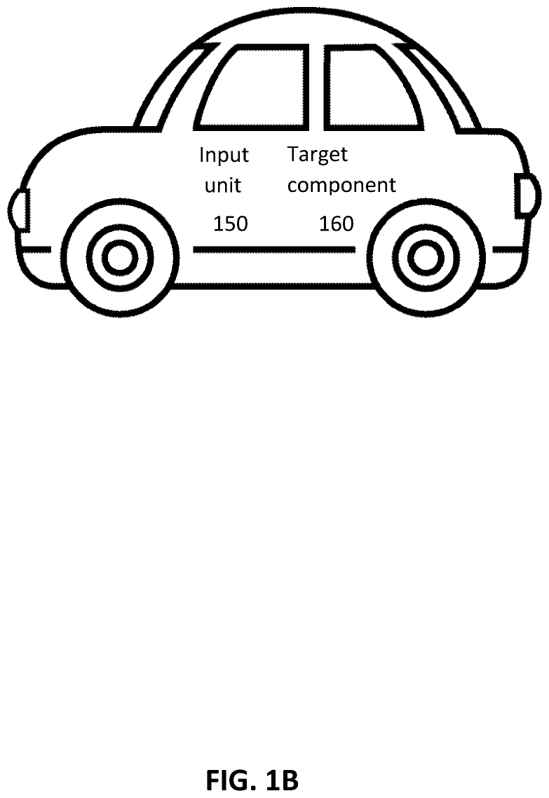

Referring now to FIG. 1A that shows an exemplary architecture of an electronic system 104 that contains several components such as a camera 108, a microphone 112, a processor 116, a connector 120, and memory 124. At least two of the components in the electronic system 104 comprise or are coupled to an authentication circuit marked as a black square on the bottom right of the component in FIG. 1, one component codes the code and the other component decodes the code in order to operate/function as required. The authentication circuit is configured to perform a coding process and/or a decoding process of the authentication signal, allowing components to ensure that the command they are performing was invoked physically by someone holding the system and not by some remote agent that could be malicious.

The electronic system 104 comprises an input unit integrated to one or more of the components of the electronic system 104. For example, the input unit may be embedded in the electronic system 104, for example in the casing, in the display device, in the body of the device and the like. The input unit is configured to store a unique non-configurable code used to enable or disable the access or usage of one of the components of the electronic system 104. For example, when a person or a computing device wishes to activate the camera 108, the person physically interacts with the input unit of the electronic system 104 such that a sensor in the electronic system 104 commands the input unit send the unique non-configurable code to the camera 108. The input unit may store multiple unique non-configurable codes, for example, one code for each component. The input unit comprises or is coupled to a communication unit, for example an internet gateway, or a touchpad, a keyboard, a microphone and the like, configured to receive a request to activate the target component in the electronic system 104. In some cases, the input unit comprises an interface with the target component, said interface is configured to enable a transfer data, including the unique non-configurable code from the memory of the input unit to a memory address accessible to the target component.

FIG. 1B shows a schematic illustration of the architecture of a vehicle having components activated using an immutable code, according to exemplary embodiments of the subject matter. The vehicle includes an input unit 150, substantially similar to an input unit from FIG. 1A, and a target component 160. Input unit can be a steering wheel, gas or brake pedal, door lock operating switch and so on. Target component can be the engine controller, wheel turn controller, break controller or door lock controller and so on.

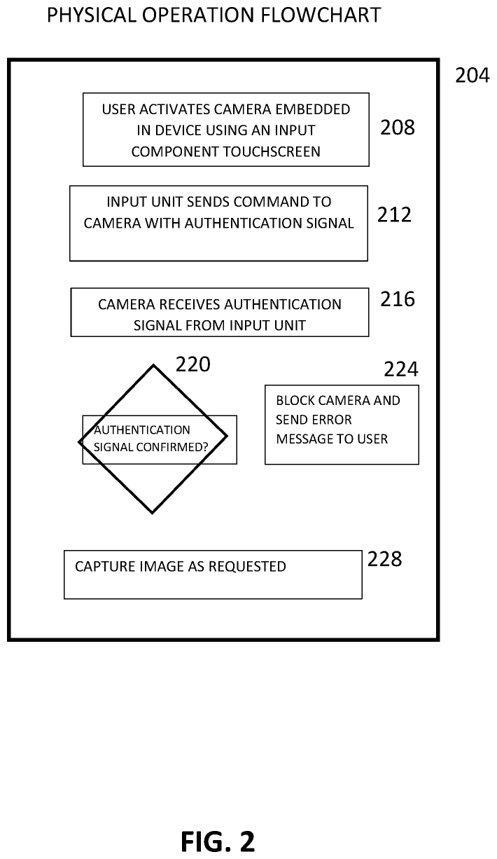

Referring now to FIG. 2, showing an exemplary flowchart 204 of steps of a method for physically operating a component from the system itself. In step 208, the user activates the “camera” embedded in the mobile electronic device using an input unit such as a button on the touchpad of the system (for example, a smartphone). The component may be located in or operate as part of a vehicle. In step 212, the touchpad, as an example of an electronic device which includes a coder module, generates an authentication code in response to being touched by the user. The touchpad then appends the authentication code to the command with the authentication code's parameters, encrypts the entire message, and sends the encrypted message to the camera.

In step 216 the camera which is an electronic device that includes a decoder module receives the authentication signal from the touchpad. The signal may be encrypted, and a processor coupled to the camera then decrypts the message and checks the code with its decoding algorithm. Since both the coding algorithm of the touchpad and the decoding algorithm of the camera have been configured and set immutably and jointly during or immediately following the integration of the entire smartphone or other device, the camera will decode, as shown in step 220. the code generated by the touchpad authenticates the fact that the command was issued physically by someone touching the touchpad. If the authentication is approved, the camera will perform the requested action in step 228. If the authentication signal is rejected, the camera moves to step 224, blocks its own operation, and may issue an error or warning signal or message to the user, according to the design of the system. The message may be a message posted on the device's screen, a voice message over the device's loudspeaker, a beep, a vibration, an email message, or a notification over a mobile application or any other notification system.

It is clear to anyone skilled in the art of designing electronic systems that the steps described above can vary widely, including, instead of a component sending a message it could be interrogated for its status, the message can be sent directly to the receiving component or indirectly through memory, processor and so on. All these are immaterial to the main ideas disclosed here. In some cases, the code may be coded by the input unit in response to a sensor that identifies the speech or face of one or more users authorized to activate the component.

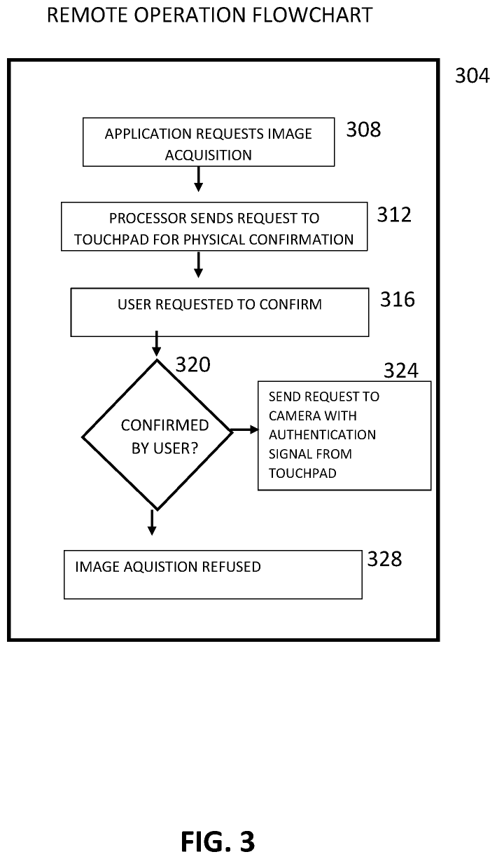

Referring now to FIG. 3 which shows a method 304 of operating a component from an application or a remote user, according to exemplary embodiments of the subject matter. In step 308, an application or a remote user requests camera operation to acquire an image or a video sequence. The camera represents an example of a component in the electric device that includes a decoder module and stores the immutable code. Step 312 discloses receiving the request to activate the camera. The request may be received at an input unit, or at a processor that receives the request.

Step 312 also discloses generating a message for the user that physically holds or touches the system to approve the camera operation. The message may be encrypted and sent to a device defined by the user that manages the operation of the camera. The message may be sent as an email, SMS, a notification over a mobile application operating on a device such as a cellular phone or a touchpad. In step 316, the user's device receives an approval request message and the option to press “approve/reject”. In step 320, if the user approves camera operation, she touches the touchpad in step 324 thereby generating an authentication code and either directly or through the processor sends an activation message to the camera to operate. If the user rejects the camera's operation the touchpad returns a “reject” message to the processor and image acquisition is refused, as shown in step 328.

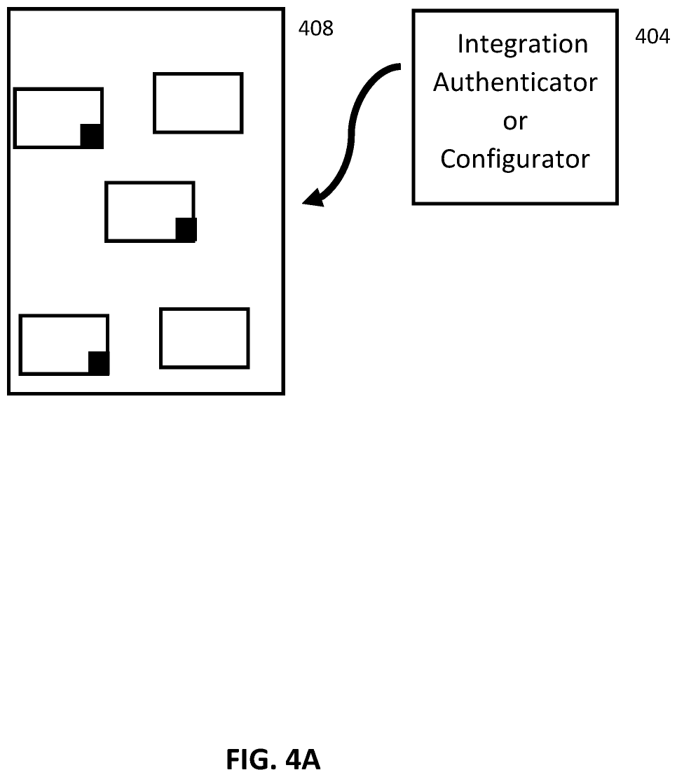

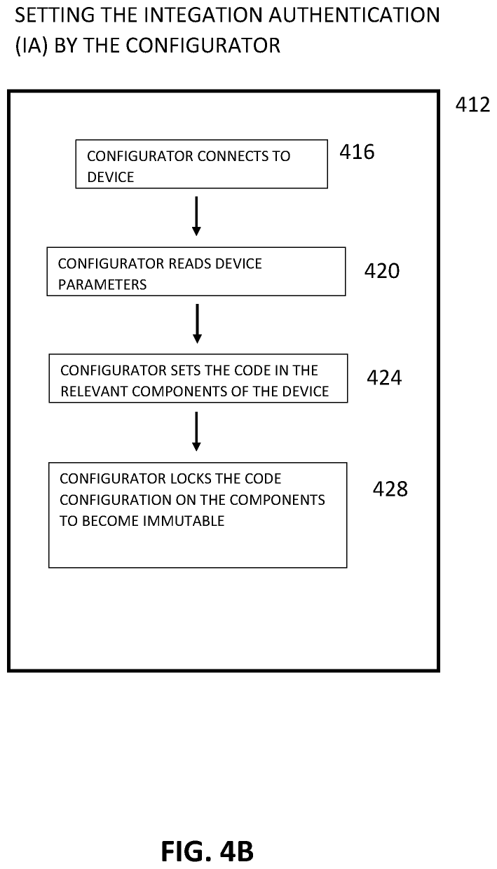

FIG. 4A shows an integration authenticator with standard smartphone components, according to exemplary embodiments of the subject matter. The figure shows the integration authentication configuration instrument (or configurator) 404 connected via a cable or wirelessly to the device or system 408 being configured. The process of setting the integration authentication (IA) by the configurator is shown in FIG. 4B. Device 408 contains some components that need configuration, being coders and/or decoders and marked by a black square on their bottom right, and several that do not, indicated by their lacking such a square. The configurator 404 may be a physical device that receives the components to be installed in the instrument, for example, cameras and speakers. The configurator 404 applies the immutable code onto the components, such that some components act as input units and store the code, and others components store a code identical to the code stored in the input unit to enable decoding. This way, when a person performs a physical gesture, for example by touching, vibrating, tilting, outputting sound, presenting an image of an object in front of a sensor in the instrument 408, the sensor identifies the gesture, the input unit of the relevant component sends the code to the target component that is activated. This way, the target component cannot be activated by a remote command.

FIG. 4B shows a generalized flowchart of a method for setting an integration authenticator to secure components of a smartphone, according to exemplary embodiments of the subject matter.

The method is shown in flowchart 412. Step 416 shows the connection of the configurator to the device being configured. The connection may be implemented by activating an internet gateway, by sending a signal over a wireless channel, such as Wi-Fi, from an antenna of the configurator to an antenna of the instrument being configured. The connection may be mechanical, for example, using physical connectors capable of transferring electric signals.

In step 420, the configurator reads the parameters of the device being configured and the device's components. The parameters may be selected from a list that includes, for example, serial numbers, clock count, and any other data required for setting the code. In step 424, the configurator sets the code on the relevant component or multiple components that have the same code. The configurator may assign a different code for different components in the same device. The code is configured either for coding, for decoding or for both. In some cases, the code may include parameters required for the encryption of inter-component messages. In step 428, the configurator locks the code circuit to become immutable. The term immutable is defined as a code that cannot be updated using any method, device, or technique known to a person skilled in the art, for example by physically engraving the code on the device.

The present invention may be a system, a method, and/or a computer program product. The computer program product may include a computer readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer-readable storage mediums includes the following: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including wired or wireless local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An electronic system comprising: a target component and an input unit, the input unit is configured to receive a command from a user of the electronic system; the input unit stores a unique non-configurable code, the input unit is configured to receive a physical request to activate the target component, the input unit is coupled to the target component with an interface component, said interface is configured to enable a transfer of the unique non-configurable authentication code from a memory of the input unit to a memory address accessible to the target component, such that when the unique non-configurable code is correct, the target component is activated.

2. The system according to claim 1, wherein the system is a smartphone.

3. The system according to claim 1, wherein the system is a vehicle.

4. The system according to claim 1, wherein the electronic system comprises at least one component configured to recognize whether a command was issued by one of the electronic system's components.

5. The system according to claim 1, wherein the input unit further comprises a coding circuit configured to code the non-configurable authentication code and wherein said code non-configurable authentication is unique for the electronic system.

6. The system according to claim 5, wherein the code configuration is set during the production of the system after all the components have been set into the system.

7. The system according to claim 5, wherein the coding and decoding circuits are immutable.

8. The system according to claim 5, wherein setting the coding and decoding keys is performed during or after device integration.

9. The system according to claim 5, wherein the code transmitted from the input unit to the component is encrypted.

10. The system according to claim 5, wherein the code changes every minute, second, or millisecond.

11. The system according to claim 5, wherein the code is produced based on the system's clock.

12. A method of controlling an operation of an electric component in a system the method comprises:
storing a non-immutable code in two components of the system;
a sensing component of the system detecting a gesture targeting a target component of the two components;
the sensing component sending the non-immutable code to the target component;
if the non-immutable code matches a code stored in the target component, activating the target component.
